(19) United States
(12) Patent Application Publication
(10) Pub. No.: US 2006/0054274 A1
(43) Pub. Date: Mar. 16, 2006

(54) Method for manufacturing optical filter

(76) Inventors: Yaw-Huei Tsai, Sijhih City (TW); Ya-Cheng Tzeng, Taoyuan County (TW)

Correspondence Address: BIRCH STEWART KOLASCH & BIRCH, PO BOX 747, FALLS CHURCH, VA, 22040-0747, US

(21) Appl. No.: 10/941,937

(22) Filed: Sep. 16, 2004

(51) Int. Cl. B32B 37/00; B29C 65/00

(52) U.S. Cl. 156/285; 156/87; 156/286

(57) ABSTRACT

A method for manufacturing an optical filter for a plasma display panel includes the steps of: disposing a metal mesh layer on a first surface of a first resin layer, which has a second surface opposite to the first surface; coating a pressure sensitive adhesive, which has a ball tack value smaller than 9.5, on a first filtering film; and bonding the first filtering film and the metal mesh layer.

### BACKGROUND OF THE INVENTION

1. Field of Invention

The invention relates to a method for manufacturing an optical filter and, in particular, to a method for manufacturing an optical filter of a plasma display panel.

2. Related Art

Plasma display panels (PDP) can charge inert gas to discharge plasma, and then the fluorescence powder can be converted to emit visible light. The plasma display panels are flat panel displays, which have the features of thin, high quality and wide viewing angle. In the field of large screen sized displays, the PDP progressively substitutes the conventional cathode ray tube (CRT) displays.

Excepting visible light, the PDP can also emit neon light (560-620 nm), electromagnetic wave, and near infrared ray (800-1000 nm). However, the neon light may interfere the displayed color of the display, and the electromagnetic wave is harmful to human bodies. In addition, the near infrared ray is similar to the wavelength of controllers of household appliances, so the household appliances may be mistakenly controlled according to the near infrared ray. As shown in FIG. 1, the conventional plasma display panel 1 has a transparent optical filer 10 installed in front thereof to shielding electromagnetic wave, neon light and near infrared ray. Herein, the optical filter 10 comprises a substrate 11 such as a tempered glass, an anti-reflective film 12, an EMI shielding film 13, and a near infrared radiation (NIR) absorbing film 14.

The anti-reflective film 12 is usually attached at the viewer side to prevent the light reflecting issue when the viewer watches the plasma display panel 1.

The EMI shielding film 13 is used to shield electro-magnetic waves, and is usually a metal layer formed on a transparent resin layer 131, such as a PET layer, having a thickness of 100-200 μm by attaching a copper film, electroplating, or electroless plating. Then, after exposure processes, developing processes and etching processes of the metal layer, an electro-magnetic wave shielding mesh 132 is obtained. Thus, the EMI shielding film 13 is completed to achieve the objective of shielding electromagnetic wave.

The NIR absorbing film 14 is used to shied neon light and near infrared ray, and is made of dyes, which can absorb specific wavelength light. The dyes, for example, are Cyanine dyes, metal complexes, diamine compounds, and the likes. The dyes are dissolved in an optical level resin, such as acrylic resin, polycarbonate resin, or polyethylene resin, and then coated on a transparent resin layer 141, such as a PET layer, having a thickness of 100-200 μm. Accordingly, a near infrared radiation (NIR) absorbing layer 142 is obtained.

Finally, each optical filter film has one side coated with a pressure sensitive adhesive 15, and the optical filter films are bonded one by one onto a substrate 11 having a thickness of about 2.5-3.5 mm.

When bonding the EMI shielding film 13, however, several little bubbles may occur between the electromagnetic wave shielding mesh 132 and pressure sensitive adhesive 15 according to the height difference of the electromagnetic wave shielding mesh 132. In such a case, the light may be irregularly scattered when passing through the optical filter, and the transmittance of the optical filter decreases. Therefore, a transparency process (degassing process) of the EMI shielding film 13 is necessary before the bonding processes, so as to decrease the bubbles.

In conventional, there are several methods for preventing or degassing the bubbles. For example, a thermal-plastic resin, such as EVA (ethylene-vinyl acetate), having a refraction index of 1.4-1.65 is firstly applied on the electro-magnetic wave shielding mesh 132 of the EMI shielding film 13, and the EMI shielding film 13 is then bonded to the NIR absorbing film 14. Alternatively, an adhering resin having a thickness of 20-30 μm is applied on the backside of the NIR absorbing film 14, and then the NIR absorbing film 14 is bonded to the electromagnetic wave shielding mesh 132 of the EMI shielding film 13. Finally, vacuum and high temperature are applied to extract the bubbles, or high temperature of less than 200° C. and pressure of 10 kg/cm² are applied to liquidize the thermal-plastic resin for performing the transparency process.

In the conventional art, a sheet coating process is performed to coat the thermal-plastic resin on the electromagnetic wave shielding mesh 132. Since the apparatus for sheet coating is very expansive, the manufacturing cost is increased. In addition, no matter applying vacuum and high temperature or applying high temperature and high pressure to remove the bubbles, the manufacturing cost is high and the condition is critical. Moreover, when using the vacuum process to extract bubbles, the process is performed by batch type. This is uneconomic and leads to the increase of the manufacturing cost.

It is therefore a subjective of the invention to provide a method for manufacturing an optical filter, which can solve the above-mentioned problems.

### SUMMARY OF THE INVENTION

In view of the foregoing, the invention is to provide a method for manufacturing an optical filter, which can degas the bubbles inside the optical filter.

To achieve the above, a method for manufacturing an optical filter, used in a plasma display panel, of the invention comprises the following steps of: disposing a metal mesh layer on a first surface of a first resin layer, wherein the first resin layer has a second surface opposite to the first surface; coating a pressure sensitive adhesive on a first filtering film, wherein the pressure sensitive adhesive has a ball tack value smaller than 9.5; and bonding the first filtering film and the metal mesh layer.

To achieve the above, a method for manufacturing an optical filter used in a plasma display panel, comprises the following steps of: disposing a metal mesh layer on a first surface of a first resin layer, wherein the first resin layer has a second surface opposite to the first surface; coating a pressure sensitive adhesive on a substrate, wherein the pressure sensitive adhesive has a ball tack value smaller than 9.5; and bonding the substrate and the metal mesh layer.

In summary, the method for manufacturing optical filers of the invention uses the pressure sensitive adhesive, having a ball tack value smaller than 9.5, to bond the metal mesh layer of the EMI shielding film and the first filtering film or to bond the metal mesh layer and the substrate. Comparing with the prior art, the method for manufacturing optical filers of the invention can degas the bubbles between the metal mesh layer and the first filtering film or between the metal mesh layer and the substrate at the conditions with lower temperature and lower pressure. In such a case, the usage of energy can be decreased, so that the manufacturing cost can be reduced. In addition, the method for manufacturing optical filers of the invention can deal with a plurality of optical filters at the same time of a single batch, so the manufacturing cost can be greatly decreased. Furthermore, the method for manufacturing optical filers of the invention coats the pressure sensitive adhesive on the first filtering film or the substrate. This process can be performed by utilizing the continuously coating machine, which is cheaper. Therefore, the manufacturing cost can be further decreased.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing the conventional plasma display panel and optical filter;

FIG. 2 is a sectional side view showing the conventional optical filter;

FIG. 3 is a flow chart showing a method for manufacturing an optical filter according to a first embodiment of the invention;

FIG. 4 is a schematic view showing a pressure sensitive adhesive, which is tested according to the JIS K 0237 12 standard for a ball tack value thereof;

FIG. 5 is a flow chart showing another method for manufacturing an optical filter according to the first embodiment of the invention;

FIG. 6 is a sectional side view showing an optical filter according to the first embodiment of the invention;

FIG. 7 is a sectional side view showing another optical filter according to the first embodiment of the invention;

FIG. 8 is a sectional side view showing an additional optical filter according to the first embodiment of the invention;

FIG. 9 is a flow chart showing a method for manufacturing an optical filter according to a second embodiment of the invention;

FIG. 10 is a sectional side view showing an optical filter according to the second embodiment of the invention;

FIG. 11 is a flow chart showing another method for manufacturing an optical filter according to the second embodiment of the invention;

FIG. 12 is a sectional side view showing an optical filter according to the second embodiment of the invention;

FIG. 13 is a sectional side view showing an additional optical filter according to the second embodiment of the invention; and

FIG. 14 is a sectional side view showing a further optical filter according to the second embodiment of the invention.

### DETAILED DESCRIPTION OF THE INVENTION

The present invention will be apparent from the following detailed description, which proceeds with reference to the accompanying drawings, wherein the same references relate to the same elements.

The invention discloses a method for manufacturing an optical filter, and for manufacturing an optical filter of a plasma display panel (PDP).

### First Embodiment

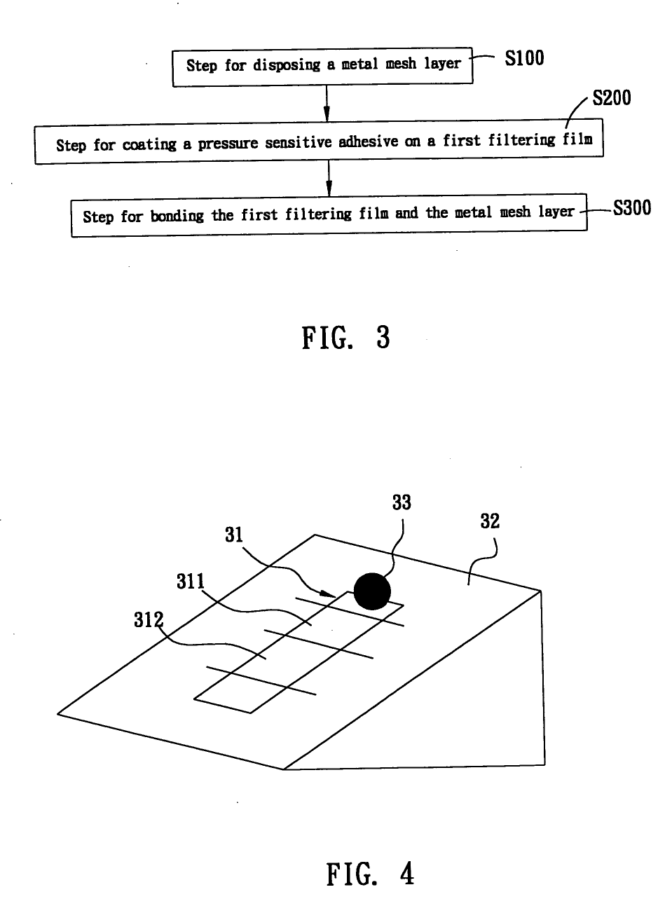

With reference to FIG. 3, the method for manufacturing an optical filter according to the first embodiment of the invention comprises a step for disposing a metal mesh layer (step S100), a step for coating a pressure sensitive adhesive on a first filtering film (step S200), and a step for bonding the first filtering film and the metal mesh layer (step S300).

With reference to FIG. 3 and FIG. 4, in the step S100, a metal mesh layer 211 is disposed on a first surface 213 of a first resin layer 212 so as to form an EMI shielding film 21. Herein, the first resin layer 212 has a second surface 214 opposite to the first surface 213.

In this case, the first resin layer 212 comprises poly(ethylene terephthalate) (PET), and has a thickness about 75 to 125 μm. The metal mesh layer 211 can be formed by exposure, develop and etch processes, and has an aperture ratio of about 85-95%. The material of the metal mesh layer 211 is, for example, copper. In the embodiment, to achieve good visible light transmittance efficient, the height of the copper lines of the metal mesh layer 211 is about 5-12 μm, the width thereof is about 8-12 μm, and the interval thereof is 200-300 μm.

In the step S200, a pressure sensitive adhesive 22, which has a ball tack value smaller than 9.5, is coated on a first filtering film 23. Herein, this coating process can be performed by a cheaper continuous coating machine.

The pressure sensitive adhesive 22 is an adhesive that can be attached to the surface of an object by a slightly press. The pressure sensitive adhesive 22 is consisting of a plastic material, a tack-strengthening resin, a plasticizing agent and a filling material. The feature of the pressure sensitive adhesive 22 may be different corresponding to the polymerization method of monomers, the molecular of the compounds, or the glass transition temperature (T_{g}). The common pressure sensitive adhesive 22 comprises crude rubber, Styrene-Butadiene Rubber (SBR), acrylic resin, and the likes.

In the present embodiment, the major material of the pressure sensitive adhesive 22 is acrylic resin dissolved in acetic ester/toluene. In the manufactured pressure sensitive adhesive 22, the solid content is about 24-26%, and the viscosity is 2500-5000 cps. The thickness of the coated pressure sensitive adhesive 22 is about 20-30 μm, and the refractive index thereof is about 1.35 to 1.50. Thus, better transmittance ration can be obtained.

In addition, the ball tack value of the pressure sensitive adhesive 22, which is measured at 80° C. according to the JIS K 0237 12 standard, is less than 9.5. As shown in FIG. 4, according to the JIS K 0237 12 standard, a sample piece of the pressure sensitive adhesive 31, which is 25 mm×120 mm, is prepared, and is placed on an oblique plate 30 with a tilt angle of 30 degrees. Then, different sized steel balls 33 ( 1/32- 32/32, x/32 series) are provided to determine whether themselves continuously roll along the testing area 312 (having a length of 100 mm) after rolling over the run-up area 311 (having a length of 100 mm). The x value of the largest steel ball, which can stop on the testing area 312, is the ball tack value of the sample piece of the pressure sensitive adhesive 31.

The first filtering film 23 is at least one selected from an anti-reflective film 23a, and an NIR absorbing film 23b.

The anti-reflective film 23a comprises a second resin layer 231a and an anti-reflective layer 232a. Herein, the second resin layer 231a is made of poly(ethylene terephthalate) (PET) and has a thickness of about 75 to 125 μm. In general, the anti-reflective film 23a is disposed at the viewer side.

The NIR absorbing film 23b comprises a third resin layer 231b and an NIR absorbing layer 232b. Herein, the third resin layer 231b comprises poly(ethylene terephthalate) (PET) and has a thickness of about 75 to 125 μm. The NIR absorbing layer 232b comprises a dye for absorbing neon light and near infrared rays. The dye is dissolved in optical resin, such as acrylic resin, polycarbonate resin, and polyethylene resin, and is then coated on the third resin layer 231b to form the NIR absorbing layer 232b.

With reference to FIG. 3 and FIG. 6, in the step S300, the first filtering film 23 and the metal mesh layer 211 are bonded. In the embodiment, the first filtering film 23 is selected form at least one of the anti-reflective film 23a and the NIR absorbing film 23b. As shown in FIG. 6, the first filtering film 23 of the embodiment is the NIR absorbing film 23b.

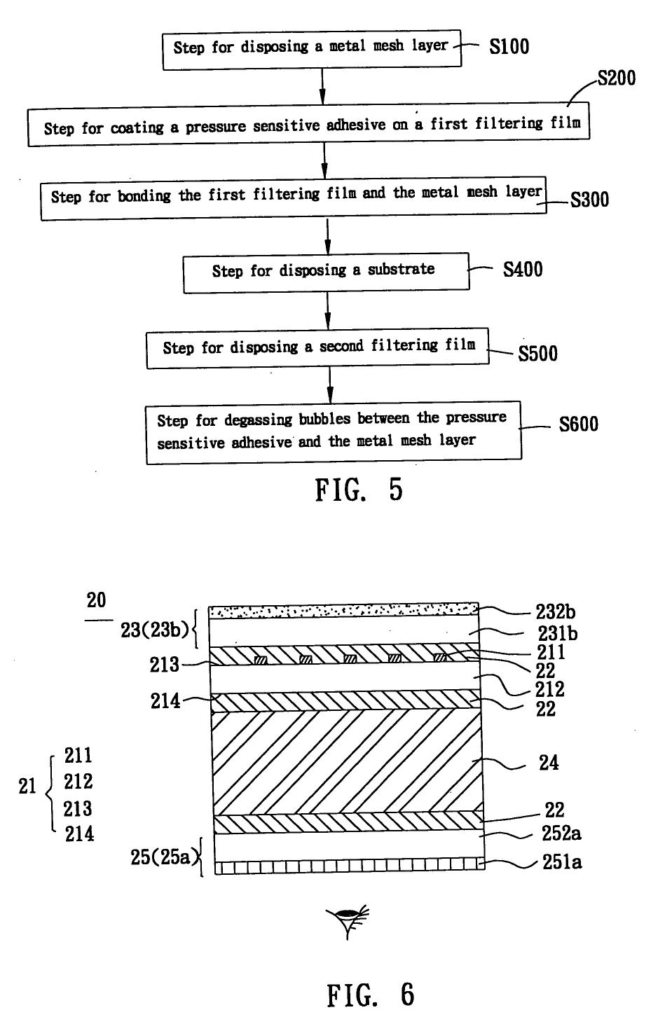

Referring to FIG. 5 and FIG. 6, the method for manufacturing an optical filter of the embodiment further comprises a step for disposing a substrate (step S400). In step S400, a substrate 24 is disposed on the second surface 214 of the first resin layer 212. Herein, a pressure sensitive adhesive 22 is used to bond one side of the substrate 24 to the second surface of the first resin layer 212. The substrate 24 is a glass substrate.

As shown in FIG. 5 and FIG. 6, the method for manufacturing an optical filter of the embodiment further comprises a step for disposing a second filtering film (S500). In step S500, a second filtering film 25 is disposed on the other side of the substrate 24. The second filtering film 25 is at least one selected from an anti-reflective film 25a and an NIR absorbing film 25b. In this case, the functions and features of the anti-reflective film 25a and the NIR absorbing film 25b are the same to those of the anti-reflective film 23a and the NIR absorbing film 23b described previously, so the detailed descriptions are omitted here for concise purpose.

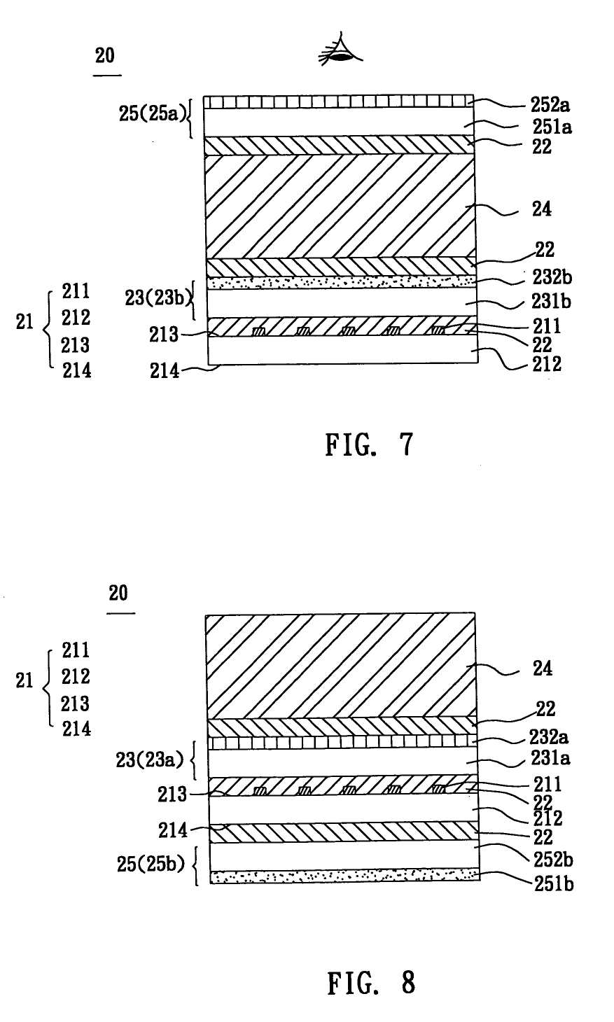

With reference to FIG. 5 to FIG. 8, in the step S400, the substrate 24 can be disposed on the first filtering film 23. In the step S500, the second filtering film 25 can be disposed on the other side of the substrate 24 as shown in FIG. 7. Alternatively, the second filtering film 25 can be disposed on the second surface 214 of the first resin layer 212 as shown in FIG. 8.

Before bonding the films and layers, the pressure sensitive adhesive 22 can be applied on one side of each of the films and layers for the next bonding processes. When bonding the films and layers, a roller can be used to apply a force of 2.0-2.4 kg for uniformly bonding the films and layers. In addition, either side of the manufactured optical filter 20 can be a viewer side of a plasma display panel. As shown in FIG. 6, the bottom side of the shown optical filter 20 is the viewer side, and, as shown in FIG. 7, the top side of the shown optical filter 20 is the viewer side.

In the present embodiment, the method for manufacturing an optical filter further comprises a step for degassing bubbles between the pressure sensitive adhesive and the metal mesh layer (step S600). In the step S600, the optical filter 20 is placed in a pressure chamber. Then, high pressure air of 5.0 to 8.0 kg/cm² is injected into the pressure chamber at a temperature about 50 to 80° C. After that, the optical filter 20 is statically stayed in the pressure chamber for 30 to 120 minutes. Accordingly, the bubbles can be removed. Herein, 40-50 pieces of optical filters 20 can be degassed in one batch.

### Second Embodiment

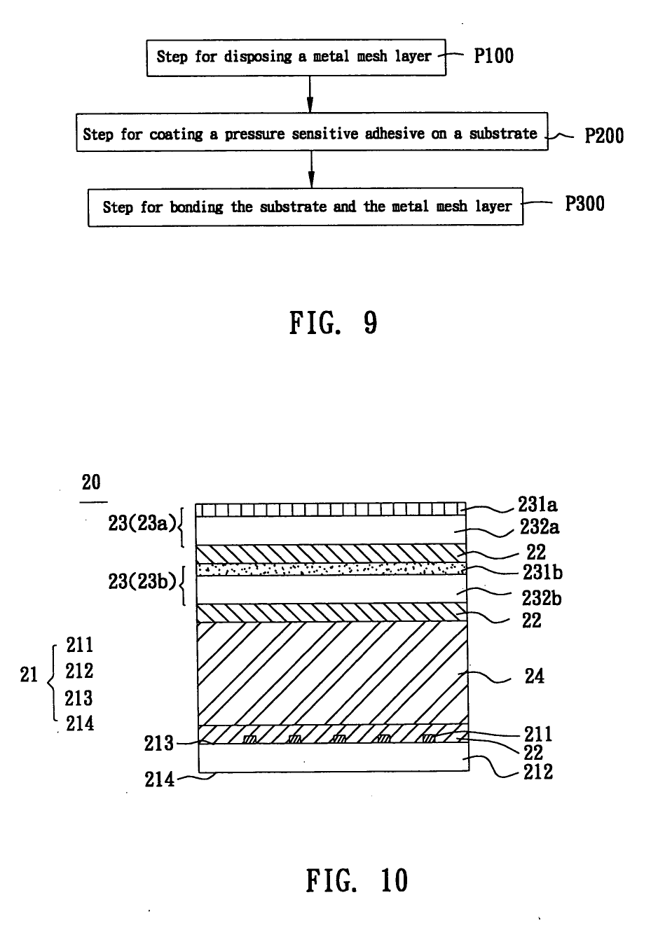

With reference to FIG. 9, a method for manufacturing an optical filter according to the second embodiment of the invention comprises a step for disposing a metal mesh layer (step P100), a step for coating a pressure sensitive adhesive on a substrate (step P200), and a step for bonding the substrate and the metal mesh layer (step P300).

The step P100 is the same to the step S100 of the first embodiment, so the detailed descriptions are omitted herein for concise purpose.

As shown in FIG. 9 and FIG. 10, in the step P200, a pressure sensitive adhesive 22 is coated on a substrate 24, and the pressure sensitive adhesive 22 has a ball tack value smaller than 9.5. Herein, this coating process can be performed by a cheaper continuous coating machine.

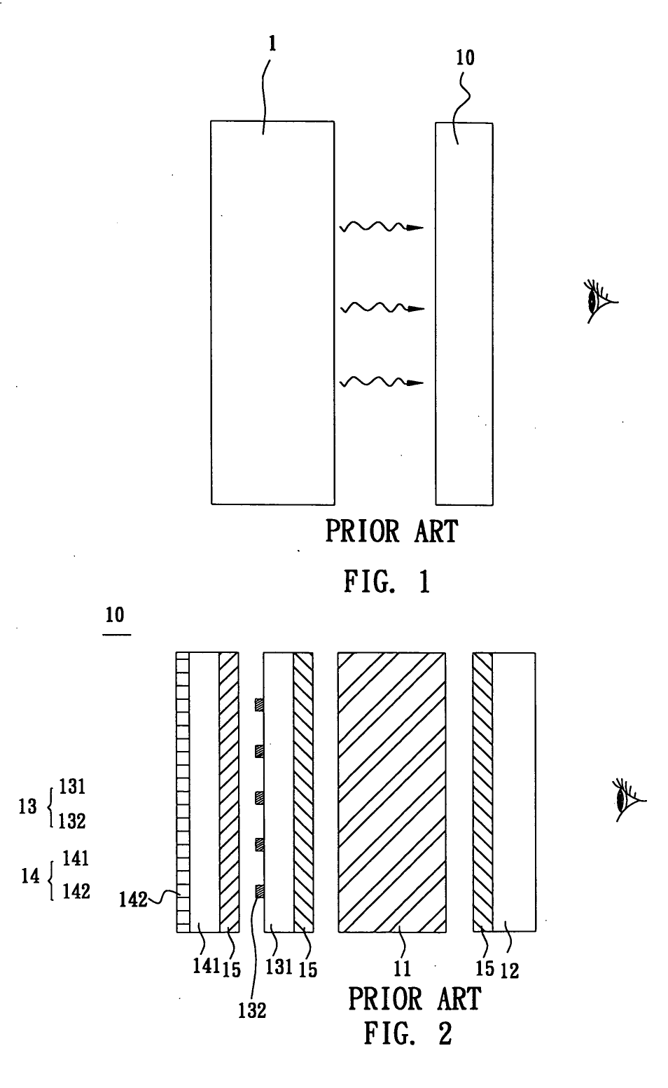

As shown in FIG. 10 and FIG. 1, in the step P300, the substrate 24 and the metal mesh layer 211 are bonded.

In the embodiment, the method for manufacturing an optical filter further comprises a step for disposing a first filtering film (P400). In step P400, a first filtering film 23 is disposed on the other side of the substrate 24. Of course, this step can dispose two first filtering films 23, including an anti-reflective film 23a and an NIR absorbing film 23b as shown in FIG. 10, on the other side of the substrate 24. The anti-reflective film 23a and the NIR absorbing film 23b can be bonded with a pressure sensitive adhesive 22.

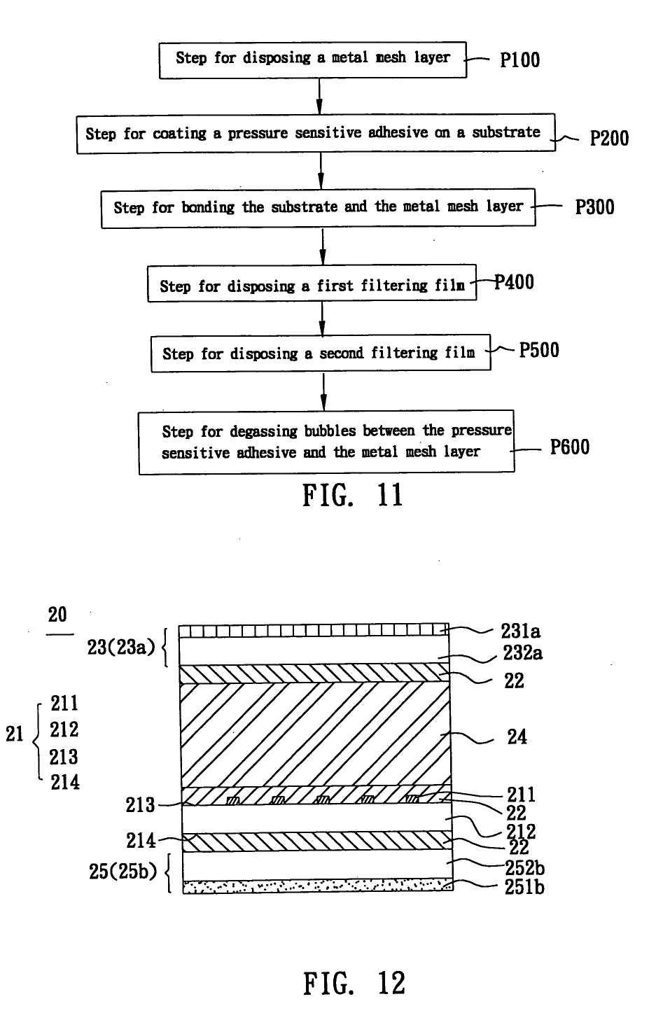

With reference to FIG. 11 and FIG. 12, the method for manufacturing an optical filter of the embodiment further comprises a step for disposing a second filtering film (P500). In step P500, a second filtering film 25 is disposed on a second surface 214 of the first resin layer 212. The second filtering film 25 is at least one selected from an anti-reflective film 25a and an NIR absorbing film 25b. As shown in FIG. 12, the second filtering film 25 is the NIR absorbing film 25b.

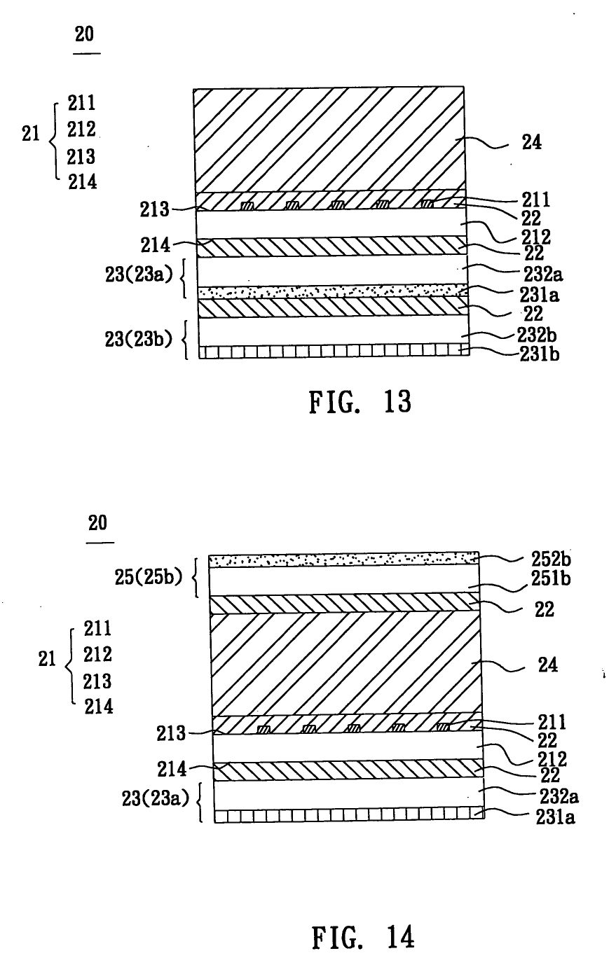

In addition, as shown in FIG. 11 and FIG. 13, in the step P400, the first filtering film 23 can be disposed on the second surface 214 of the first resin layer 212. As shown in FIG. 13, this step can dispose two first filtering films 23 on the second surface 214 of the first resin layer 212. With reference to FIG. 11 and FIG. 14, the step P400 can dispose one first filtering film 23 on the second surface 214, and the step P500 can dispose the second filtering film 25 on the other side of the substrate 24.

Before bonding the films and layers, the pressure sensitive adhesive 22 can be applied on one side of each of the films and layers for the later bonding processes. When bonding the films and layers, a roller can be used to apply a force of 2.0-2.4 kg for uniformly bonding the films and layers. In addition, either side of the manufactured optical filter 20 can be a viewer side of a plasma display panel. As shown in FIG. 6, the bottom side of the shown optical filter 20 is the viewer side, and, as shown in FIG. 7, the top side of the shown optical filter 20 is the viewer side.

In the current embodiment, the method for manufacturing an optical filter further comprises a step for degassing bubbles between the pressure sensitive adhesive and the metal mesh layer (step P600). In the step P600, the optical filter 20 is placed in a pressure chamber. Then, high pressure air of 5.0 to 8.0 kg/cm² is injected into the pressure chamber at a temperature about 50 to 80° C. After that, the optical filter 20 is statically stayed in the pressure chamber for 30 to 120 minutes. Accordingly, the bubbles can be removed. Herein, 40-50 pieces of optical filters 20 can be degassed in one batch.

As mentioned above, the method for manufacturing optical filers of the invention uses the pressure sensitive adhesive, having a ball tack value smaller than 9.5, to bond the metal mesh layer of the EMI shielding film and the first filtering film or to bond the metal mesh layer and the substrate. Comparing with the prior art, the method for manufacturing optical filers of the invention can degas the bubbles between the metal mesh layer and the first filtering film or between the metal mesh layer and the substrate at the conditions with lower temperature and lower pressure. In such a case, the usage of energy can be decreased, so that the manufacturing cost can be reduced. In addition, the method for manufacturing optical filers of the invention can deal with a plurality of optical filters at the same time of a single batch, so the manufacturing cost can be greatly decreased. Furthermore, the method for manufacturing optical filers of the invention coats the pressure sensitive adhesive on the first filtering film or the substrate. This process can be performed by utilizing the continuously coating machine, which is cheaper. Therefore, the manufacturing cost can be further decreased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for manufacturing an optical filter used in a plasma display panel, comprising:
disposing a metal mesh layer on a first surface of a first resin layer, wherein the first resin layer has a second surface opposite to the first surface;
coating a pressure sensitive adhesive on a first filtering film, wherein the pressure sensitive adhesive has a ball tack value smaller than 9.5; and
bonding the first filtering film and the metal mesh layer.

2. The method of claim 1, wherein the first resin layer comprises poly(ethylene terephthalate) (PET), and has a thickness of about 75 to 125 μm.

3. The method of claim 1, wherein the ball tack value of the pressure sensitive adhesive is measured at 80° C. according to a JIS K 0237 12 standard.

4. The method of claim 1, wherein the thickness of the pressure sensitive adhesive is about 20 to 30 μm.

5. The method of claim 1, wherein the refractive index of the pressure sensitive adhesive is about 1.35 to 1.50.

6. The method of claim 1, wherein the pressure sensitive adhesive is made of acrylic resin.

7. The method of claim 1, wherein the first filtering film is at least one selected from an anti-reflective film and a near infrared radiation (NIR) absorbing film.

8. The method of claim 1, further comprising:
degassing bubbles between the pressure sensitive adhesive and the metal mesh layer, comprising:
placing the optical filter in a pressure chamber,
injecting high pressure air of 5.0 to 8.0 kg/cm² into the pressure chamber at a temperature about 50 to 80° C., and
statically staying the optical filter in the pressure chamber for 30 to 120 minutes.

9. The method of claim 1, further comprising:
disposing a substrate on the second surface of the first resin and/or above the first filtering film.

10. The method of claim 9, wherein the substrate is made of glass.

11. The method of claim 9, further comprising:
disposing a second filtering film on an other side of the substrate and/or on the second surface of the first resin layer, wherein the second filtering film is at least one selected from an anti-reflective film and an NIR absorbing film.

12. A method for manufacturing an optical filter used in a plasma display panel, comprising:
disposing a metal mesh layer on a first surface of a first resin layer, wherein the first resin layer has a second surface opposite to the first surface;
coating a pressure sensitive adhesive on a substrate, wherein the pressure sensitive adhesive has a ball tack value smaller than 9.5; and
bonding the substrate and the metal mesh layer.

13. The method of claim 12, wherein the first resin layer comprises poly(ethylene terephthalate) (PET), and has a thickness of about 75 to 125 μm.

14. The method of claim 12, wherein the ball tack value of the pressure sensitive adhesive is measured at 80° C. according to a JIS K 0237 12 standard.

15. The method of claim 12, wherein the thickness of the pressure sensitive adhesive is about 20 to 30 μm.

16. The method of claim 12, wherein the refractive index of the pressure sensitive adhesive is about 1.35 to 1.50.

17. The method of claim 12, wherein the pressure sensitive adhesive is made of acrylic resin.

18. The method of claim 12, further comprising:
degassing bubbles between the pressure sensitive adhesive and the metal mesh layer, comprising:
placing the optical filter in a pressure chamber,
injecting high pressure air of 5.0 to 8.0 kg/cm² into the pressure chamber at a temperature about 50 to 80° C., and
statically staying the optical filter in the pressure chamber for 30 to 120 minutes.

19. The method of claim 12, further comprising:
at least disposing a first filtering film on an other side of the substrate and/or on the second surface of the first resin layer, wherein the first filtering film is at least one selected from an anti-reflective film and an NIR absorbing film.

20. The method of claim 19, further comprising:
disposing a second filtering film on an other side of the substrate and/or on the second surface of the first resin layer, wherein the second filtering film is at least one selected from an anti-reflective film and an NIR absorbing film.
